(19) United States
(12) Patent Application Publication
(10) Pub. No.: US 2008/0207244 A1
(43) Pub. Date: Aug. 28, 2008

(54) Method for the Transmission of Messages and a Correspondingly Equipped Motor Vehicle

(75) Inventor: Marco Roggero, Stuttgart (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/910,470

(22) PCT Filed: Mar. 31, 2006
(86) PCT No.: PCT/IB06/50972

§ 371 Date: Oct. 2, 2007

(30) Foreign Application Priority Data
Apr. 4, 2005 (EP) 05102647.4

(51) Int. Cl. H04B 7/00

(52) U.S. Cl. 455/522

(57) ABSTRACT

To provide a method for the transmission of messages between mobile nodes (A, B, C) in an ad hoc network that will ensure reliable transmission of relevant information even with a large number of nodes (A, B, C), it is proposed that a signal strength and a repetition frequency be controlled in dependence on a speed of the mobile node (A) and on a number of mobile nodes (B, C). Furthermore, a correspondingly equipped motor vehicle is specified.

The invention relates to a method for the transmission of messages between mobile nodes in an ad hoc network, and to a correspondingly equipped motor vehicle.

In an ad hoc network of mobile nodes, which for the purpose of exchange of information between the nodes is self-organizing without a stationary control device, the messages are exchanged between the individual nodes wirelessly via radio links. Such an ad hoc network is inter alia formed by motor vehicles in road traffic that are fitted with the appropriate transmitting/receiving devices and other devices known to the person skilled in the art for evaluating and generating desired messages. Each vehicle can here be regarded as a mobile node of the ad hoc network. With such networks it is possible, for example, for an emergency services vehicle to alert other vehicles to its presence as it approaches a traffic intersection by exchanging corresponding information, and for the intersection to be kept clear for rapid passage of the emergency services vehicle. The vehicles are similarly able to exchange information about their respective speeds, into order to avoid a collision when changing lane or filtering into a lane. For this purpose, inter alia medium access protocols are used, such as the IEEE 802.11 protocol, which controls access to a shared communication medium without the use of a central control device.

In a wireless ad hoc network without a central control device, the number of participating nodes as well as the number of connections between the nodes varies continuously. In addition, the external circumstances are also constantly changing, so that, for example, with a high traffic density on a roadway, it may happen that too large a number of messages to be exchanged with one another will lead to what is known as “congestion” of the communication medium, so that potentially important traffic information, for example, concerning an accident, cannot reliably be transmitted to all mobile nodes.

For example, in a traffic tailback on a multi-lane motorway, in which the vehicles are moving hardly at all or only at very low speed, virtually no messages need to be exchanged between the individual vehicles within the tailback since a collision of these stationary vehicles is just about impossible. At the end of the tailback, however, approaching vehicles ought to be alerted to the existence of the tailback by transmission of appropriate messages. Similarly, there is a need for a single, slow-moving vehicle to alert the following vehicles, which are possibly traveling faster, to its slow vehicle speed by transmitting corresponding messages. Then again, a fast-moving vehicle needs to alert the vehicles traveling ahead, and possibly more slowly, to its presence, so that the fast-moving vehicle can overtake them safely.

U.S. Pat. No. 6,121,896 describes a vehicle early warning system, in which the rear of each vehicle is fitted with a transmitting device and the front of each vehicle is fitted with a receiving device. In this case, for example, when one vehicle brakes, a corresponding warning signal is transmitted to the following vehicles, so that a mass pile-up can be avoided, since the drivers of the following vehicles are alerted earlier to the braking operation of the vehicle ahead. At the same time, the warning signals received by one vehicle are automatically relayed via the rear transmitting device to the other vehicles following it.

From the publication entitled “Dynamic Integrated Transmission Control” by FUKUI R., KOIKE H., OKADA H., Information Network Laboratory, Kansai University, Japan, for the exchange of messages between a plurality of vehicles it is known to transmit message packets at a transmission frequency that is greater, the faster the vehicle is moving. In this way, the number of superimposed messages is reduced, and their collision in the communication medium is avoided.

United States patent 2002/0030611 A1 describes a method for transmitting data packets between motor vehicles, in which a transmission interval is controllable as a function of the volume of data to be transmitted. If, for example, a vehicle receives many data packets, then data packets may be transmitted at a lower repetition rate from that vehicle in order to avoid overlaps in the transmission of data.

The publication entitled “Adaptive Broadcast for Travel and Traffic Information Distribution” by Wischhof L., Ebner A., Rohling H., Technische Universitat Hamburg-Haburg, describes a method for the exchange of information between mobile nodes of a network, in which the time between two consecutive message transmissions can be reduced by the influence of external circumstances.

The publication entitled “GPS-Based Message Broadcasting for Inter-vehicle Communication” by Sun M., Feng W., Lai T., Honda R & D Americas Fundamental Research Laboratories discloses a method in which novel protocols that make use of information in the GPS system are used for transmitting messages.

It is an object of the present invention to specify a method for transmitting messages between mobile nodes in an ad hoc network, in which an incorrect transmission or the overlap of a plurality of transmitted messages, especially in the case of large traffic densities, is excluded in order to increase road safety. Furthermore, a correspondingly equipped motor vehicle is to be specified.

These objects are achieved by the features specified in claims 1 and 9.

The central idea of the invention is that messages are transmitted between the mobile nodes in a manner known per se, for example, using the IEEE 802.11 protocol, in order to exchange information relevant to traffic between the mobile nodes, i.e. in particular between different motor vehicles. Here, however, the signal strength with which the individual messages are transmitted from one mobile node to the others, as well as the repetition frequency, i.e. the time interval between two transmitted messages or data packets, are controlled in dependence on the speed at which the mobile node is moving and on the number or the area density of the other mobile nodes.

It goes without saying that the method is implemented in respect of hardware and/or software preferably in a central control unit of the motor vehicle for controlling all functions, a speed signal of the mobile node, that is to say, the vehicle, being provided in the control unit from sensors already present in the vehicle, so that the current speed of the vehicle can be used in the control of the message transmission. The area density, i.e. the number of other mobile nodes in the transmitting and receiving range of the mobile node, can be determined, for example, by the number of what are known as “hello messages” of the other nodes that the mobile node receives using suitably configured receiving devices, the other nodes notifying their presence in the transmitting and receiving range by these “hello messages” in order to be able to exchange information by means of the messages.

The advantage of the invention is that the method can be carried out in a simple manner, for example, in a central control unit of a motor vehicle, so that virtually no additional expense is needed to implement the method. By adjusting the signal strength as well as the repetition frequency to the speed of the mobile node, and to the number of other mobile nodes that with it form the self-organizing ad hoc network, information that is especially relevant to road traffic, such as the development of a tailback, can be reliably routed to all nodes in the ad hoc network.

Advantageous embodiments of the invention are characterized in the subsidiary claims.

According to claim 2, the signal strength of the messages transmitted from a mobile node is preferably changed in different directions in space. This means, for example, in the case of a motor vehicle that represents a mobile node, that a signal strength forwards in the direction of travel and/or backwards in relation to the direction of travel is substantially stronger in order reliably to supply the other vehicles traveling ahead and behind respectively with information, for example, about the speed of the vehicle transmitting the messages. On the other hand, a signal strength to each side, viewed in the direction of travel, can be chosen to be substantially weaker, since to the left or to the right information needs to be transmitted at most to a vehicle on an adjacent lane, so that a shorter range is sufficient here. It goes without saying that for this purpose the vehicle is preferably provided with four transmitting and/or receiving devices, which are arranged on the front, rear and on the sides of the vehicle and can be operated, for example, by a central control unit in each case with different signal strengths. Similarly, the repetition frequency of the transmitted messages in the different directions can be selected to be different each time, since, for example, to the side, merely a vehicle traveling on the adjacent lane has to be notified of the presence of the transmitting vehicle, and thus substantially less data or fewer messages need to be transmitted than to a following vehicle, to alert the latter vehicle, for example, to a tailback ahead.

Referring to the construction proposed in claim 3, the repetition frequency of the transmitted messages is proportional to the speed of the mobile node. In particular the hello messages emitted by a mobile node are transmitted at a repetition frequency proportional to the vehicle speed, so that, for example, at a relatively high vehicle speed, which leads to a marked variation in the number of mobile nodes within the transmitting and receiving range of this fast-moving vehicle, the other mobile nodes are always informed of the presence of said vehicle. If the vehicle is only moving relatively slowly, then the number of mobile nodes in the transmitting and receiving range also remains substantially more consistent, so that in this case the number of mobile nodes requires to be updated only at larger time intervals.

In accordance with claim 4, the minimum repetition frequency is preferably proportional to a possible maximum speed of the mobile node. Such a maximum speed can be prescribed, for example, by a speed limit on a highway. So on a road to be traveled slowly, it is unnecessary to transmit the hello messages at a high repetition frequency, since the vehicle travels only slowly and thus the number of mobile nodes in the transmitting and receiving range remains relatively constant. At a higher maximum permissible speed, the minimum rate of repetitions of, for example, the hello messages, is accordingly increased.

In an especially advantageous embodiment, characterized in claim 5, the repetition frequency is inversely proportional to the density of the mobile nodes in the transmitting and receiving range of the mobile node. This means that the more mobile nodes there are within the transmitting and receiving range, the fewer messages or hello messages are transmitted by each mobile node, in order thus to reduce the total number of messages transmitted by all mobile nodes. The probability of an overlap between two messages, that is to say, a congestion of the communication medium, is therefore reduced.

Claim 6 proposes that the signal strength with which messages are emitted from the mobile nodes forwards in the direction of movement be proportional to the vehicle speed, and the signal strength of the messages emitted backwards be inversely proportional thereto. Thus, for example, a fast-moving vehicle that is approaching from behind slower vehicles traveling in front can advise these other mobile nodes in good time, by virtue of the high signal strength forwards in the direction of travel, that this mobile node is approaching quickly, so that these other mobile nodes are able if need be to clear a lane. In the case of the signals emitted backwards, however, a substantially lower signal strength is sufficient, because it is hardly likely that nodes moving even faster will approach from behind, so that there are virtually no following mobile nodes that would have to be informed of the driving state of this mobile node.

For that purpose, claim 7 specifies that the signal strength transmitted backwards with respect to the direction of movement is at least proportional to an admissible maximum speed, for example, on a roadway. It is thus ensured that where a route is to be covered slowly, only signals of low signal strength are emitted, since, because of the slow speed of the node, braking is always possible, so that only the other vehicle driving immediately behind this vehicle has to be informed of the driving state. On a motorway where driving is faster, however, several other road users following the vehicle ought to be informed. The higher signal strength serves that purpose. To the person skilled in the art it is clear that a position signal of a GPS system can be used to determine a momentarily admissible maximum speed, in order to determine the admissible maximum speed from stored route-specific information.

In the case of very slowly moving mobile nodes, or even stationary nodes, in accordance with claim 8 signals are intended to be emitted only backwards, viewed in the direction of movement of the node. If, for example, several vehicles are in a tailback, then they are either stationary or are moving forwards only slightly. In such a case a driver of a vehicle requires no information about the vehicles further in front, since he himself is aware of the queuing. The sole factor of interest here is the informing of following road users that they are approaching, for example, the end of a tailback, so that only signals backwards with respect to the direction of driving are emitted. It goes without saying that a minimum speed, up to which only signals backwards with respect to the direction of movement are emitted, can preferably be adjustable, for example 5 km/h. Similarly, the signal strength of the signals emitted to the side can be reduced.

These and other aspects of the invention are apparent from and will be elucidated with reference to the embodiments described hereinafter.

In the drawings:

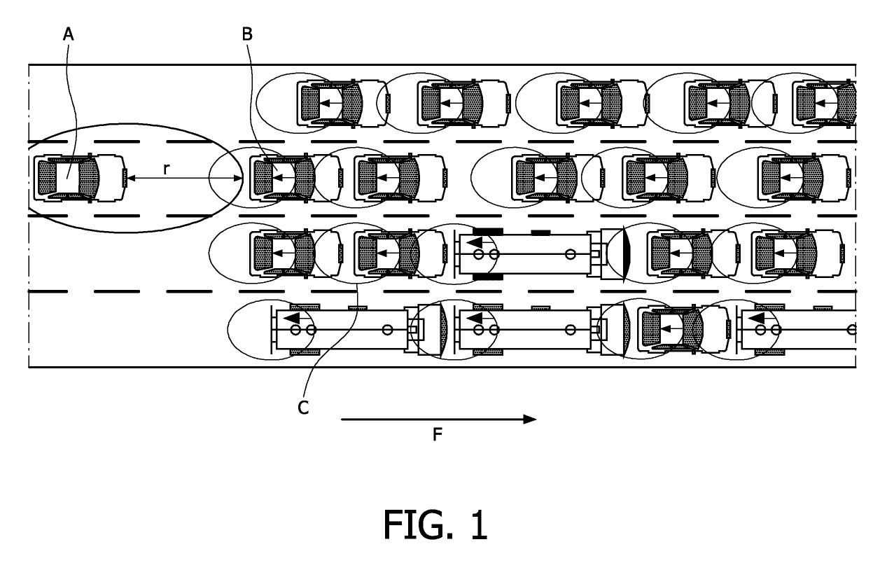

FIG. 1 shows a vehicle approaching the end of a tailback,

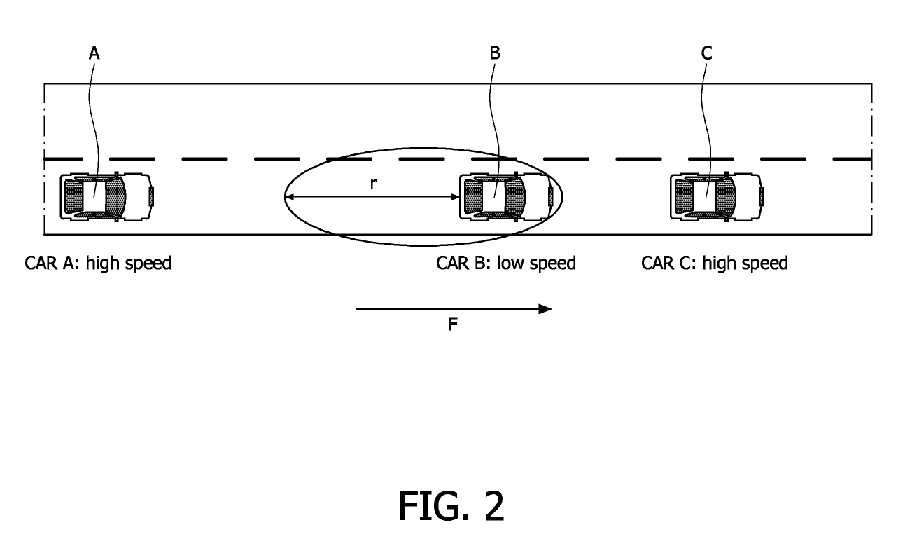

FIG. 2 shows a slow-moving vehicle

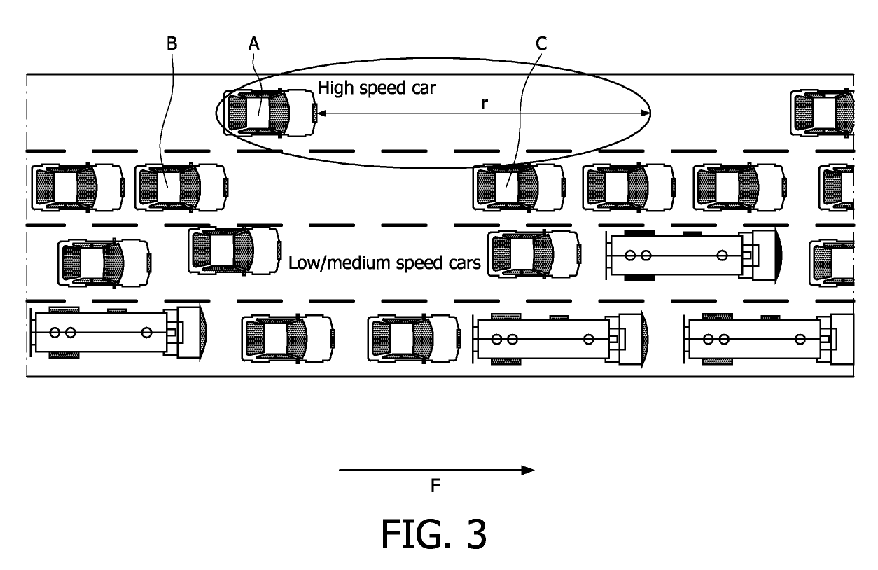

FIG. 3 shows a fast-moving vehicle, and

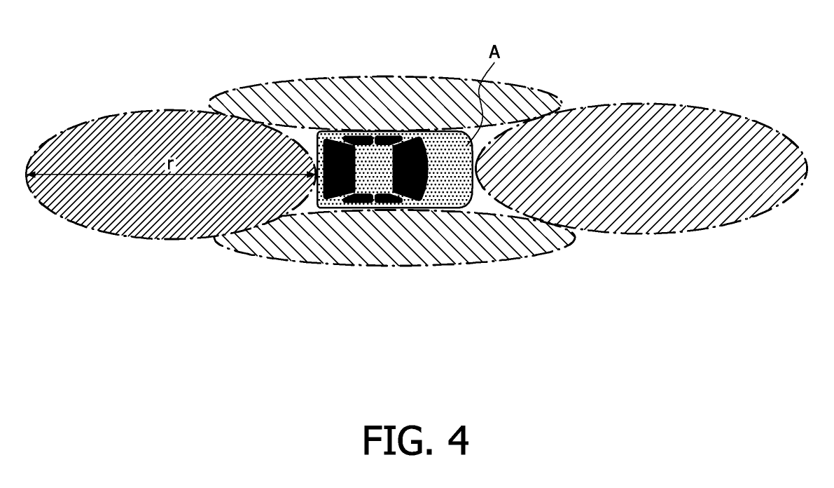

FIG. 4 shows a vehicle with different signal strengths.

FIGS. 1, 2 and 3 each show different vehicles, each forming a respective mobile node A, B, C of a self-organizing ad hoc network. The nodes B and C are situated at the end of a tailback on a multi-lane roadway and the node A is approaching the end of this tailback at high speed.

To prevent node A from running into the end of the tailback, it is necessary to transmit traffic-relevant messages between the nodes A, B and C. From the illustration in FIG. 1, it is clear that the node A has a greater transmission range r forwards in the direction of travel indicated by the arrow F than the nodes B, C have backwards with respect to their direction of travel F. This greater transmission range r is achieved in that signals, for example, hello messages known per se, are transmitted from node A forwards in the direction of travel F with a relatively high signal strength. The node A is thus able to warn of his approach substantially earlier, wherein then, as node A approaches the end of the tailback, the corresponding information that he must now reduce his speed can be communicated to him. Similarly, the repetition frequency with which messages can be transmitted from node A forwards in the direction of travel can be increased proportionally to the speed of movement of the node A, in order to obtain an update of the number of nodes in the transmitting and receiving range correspondingly more frequently.

FIG. 2 reproduces a slow-moving motor vehicle, which represents the node B, as well as two vehicles A, C traveling faster in the direction of travel F indicated by the arrow. The slower-moving node B will transmit signals backwards with a higher signal strength, to alert in particular fast-moving and hence fast-approaching other road users to its slower vehicle speed. The node B accordingly has a greater transmission range r to the rear.

FIG. 3 reproduces a typical overtaking sequence on a multi-lane roadway, a fast-moving vehicle A having a large transmission range r forwards in the direction of travel F being located on the left-hand lane, here shown at the top. Virtually no messages need to be transmitted backwards from this vehicle A, since it is hardly likely that an even faster vehicle will run into it. Similarly, virtually no messages need to be exchanged sideways, since the other road users on the other lanes are merely being overtaken. Only the usual hello messages need to be transmitted sideways to notify the presence of vehicle A in the ad hoc network.

FIG. 4 reproduces a motor vehicle A, which forwards and backwards as well as sideways to the left and to the right with respect to the direction of travel F is able to transmit signals of different signal strengths, as indicated by the different transmission ranges r. For that purpose, the vehicle is preferably provided with four transmitting and/or receiving devices controllable independently of one another. Similarly, the repetition frequencies in the different directions can be adjusted independently of one another in the desired manner.

### LIST OF REFERENCE NUMBERS

A,B,C Nodes
r Transmission range
F Direction of travel

1. A method for transmitting messages between mobile nodes (A, B, C) in an ad hoc network, characterized in that a signal strength and a repetition frequency are controlled in dependence on a speed of the mobile node (A) and on a number of the mobile nodes (B, C).

2. A method as claimed in claim 1, characterized in that in different directions the signal strength and/or the repetition frequency is adjusted in each case differently.

3. A method as claimed in claim 1, characterized in that the repetition frequency selected is proportional to the speed of the mobile node (A, B, C).

4. A method as claimed in 1, characterized in that a minimum repetition frequency that is proportional to the admissible maximum speed of the mobile node (A, B, C) is selected.

5. A method as claimed in claim 1, characterized in that a repetition frequency that is inversely proportional to the number of mobile nodes (A, B, C) in a transmitting and receiving range is selected.

6. A method as claimed in claim 1, characterized in that a signal strength forwards in the direction of movement (F) that is proportional to the speed of the mobile node (A, B, C) and/or a signal strength backwards with respect to the direction of movement (F) that is inversely proportional to the speed of the mobile node (A, B, C) is selected.

7. A method as claimed in claim 1, characterized in that a minimum value of the signal strength emitted backwards with respect to the direction of movement (F) that is proportional to an admissible maximum speed is selected.

8. A method as claimed in claim 1, characterized in that below a limit speed or when the mobile node (A, B, C) is stationary, a hello message is emitted only backwards with respect to the direction of movement (F).

9. A motor vehicle that is fitted with transmitting and receiving devices for transmitting messages to other motor vehicles in an ad hoc network, characterized in that the motor vehicle has four independent transmitting and receiving devices, which, viewed in the direction of travel (F), emit their signals respectively forwards, backwards and sideways to the left and to the right.

10. A motor vehicle as claimed in claim 9, characterized in that the signal strength of each transmitting and receiving device and/or a repetition frequency is adjustable in each case independently of one another.
